(19) United States
(12) Patent Application Publication
(10) Pub. No.: US 2023/0047799 A1
(43) Pub. Date: Feb. 16, 2023

(54) PIXEL STRUCTURE, DISPLAY PANEL, AND DISPLAY DEVICE

(71) Applicants: Ordos Yuansheng Optoelectronics Co., Ltd., Ordos (CN); BOE Technology Group Co., Ltd., Beijing (CN)

(72) Inventors: Wei REN, Beijing (CN); Wei LI, Beijing (CN); Yanfeng LI, Beijing (CN); Haoyi XIN, Beijing (CN); Jing LI, Beijing (CN); Jingjing XU, Beijing (CN); Chenrong QIAO, Beijing (CN); Yanyong SONG, Beijing (CN); Xu QIAO, Beijing (CN); Rula SHA, Beijing (CN); Min ZHANG, Beijing (CN)

(21) Appl. No.: 17/976,079

(22) Filed: Oct. 28, 2022

Related U.S. Application Data
(63) Continuation-in-part of application No. 17/441,272, filed on Jan. 1, 0001.

(51) Int. Cl. G02F 1/1343; G09G 3/36

(52) U.S. Cl. CPC G02F 1/134309; G02F 1/13439; G09G 3/36; G02F 2201/121; G02F 2201/123; G02F 1/137

(57) ABSTRACT

Provided is a pixel structure. The pixel structure includes: a first electrode, a second electrode, and a liquid crystal layer that are disposed on one side of a substrate and successively stacked, wherein one of the first electrode and the second electrode is a pixel electrode and the other of the first electrode and the second electrode is a common electrode, and the second electrode includes a plurality of electrode branches sequentially arranged in a first direction, wherein each of the electrode branches includes a first end portion, a body portion, and a second end portion that are successively connected in a second direction, the body portion including at least one body segment.

### CROSS-REFERENCE TO RELATED APPLICATION

This application is a continuation in part application of U.S. application Ser. No. 17/441,272, filed on Sep. 20, 2021, and the continuation in part application claims priority to international application No. PCT/CN2022/090564, the entire contents of which are incorporated herein by reference.

### TECHNICAL FIELD

The present disclosure relates to the field of display technologies, and in particular, relates to a pixel structure, a display panel, and a display device.

### BACKGROUND

Liquid crystal display (LCD) panels are widely used in display apparatuses due to low power consumption.

### SUMMARY

In an aspect, a pixel structure is provided. The pixel structure includes:

a first electrode, a second electrode and a liquid crystal layer disposed on one side of a substrate and successively stacked, wherein one of the first electrode and the second electrode is a pixel electrode and the other of the first electrode and the second electrode is a common electrode, and the second electrode includes:

a plurality of electrode branches sequentially arranged in a first direction, wherein each of the electrode branches includes a first end portion, a body portion and a second end portion that are successively connected in a second direction, the body portion including at least one body segment, and an extending direction of each of the body segment, extending direction of the first end portion and an extending direction of the second end portion being intersected with the second direction, and the second direction being perpendicular to the first direction;

wherein the first end portions of the plurality of electrode branches are communicated with each other, the second end portions of the plurality of electrode branches are communicated with each other, the first end portions of at least two electrode branches are communicated with each other in an arc, the second end portions of at least two electrode branches are communicated with each other in an arc, and a slit is disposed between each of the two adjacent electrode branches, the slit including a first slit segment, a second slit segment and a third slit segment that are successively connected in the second direction, and an angle between at least one of the first slit segment and the third slit segment and the second slit segment being equal to 180 degrees.

In another aspect, a display panel is provided. The display panel includes: a substrate, a plurality of pixel structures described in the above aspect, and a color filter disposed on a side, distal from the substrate, of the pixel structures.

In still another aspect, a display device is provided. The display device includes: a drive circuit, and a display panel described in the above aspect;

wherein the drive circuit is connected to the display panel and is configured to drive signals to the pixel structures in the display panel.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a pixel electrode in the related art;

FIG. 2 is a schematic diagram of liquid crystal rotation according to an embodiment of the present disclosure;

FIG. 3 is a schematic diagram of liquid crystal rotation in a display panel according to an embodiment of the present disclosure;

FIG. 4 is a schematic diagram of liquid crystal rotation in a display panel in the related art;

FIG. 5 is a schematic diagram of an electric field of the pixel electrode shown in FIG. 1;

FIG. 6 is a schematic structural diagram of a pixel electrode according to an embodiment of the present disclosure;

FIG. 7 is a schematic diagram of an electric field of the pixel electrode shown in FIG. 6;

FIG. 8 is a schematic diagram of liquid crystal rotation in a display panel after a squeezing force is released according to an embodiment of the present disclosure;

FIG. 9 is a schematic structural diagram of another pixel electrode according to an embodiment of the present disclosure;

FIG. 10 is a schematic diagram of an electric field of the pixel electrode shown in FIG. 9;

FIG. 11 is a schematic diagram of another type of liquid crystal rotation in a display panel after a squeezing force is released according to an embodiment of the present disclosure;

FIG. 12 is a schematic structural diagram of still another pixel electrode according to an embodiment of the present disclosure;

FIG. 13 is a schematic structural diagram of yet another pixel electrode according to an embodiment of the present disclosure;

FIG. 14 is a schematic structural diagram of still yet another pixel electrode according to an embodiment of the present disclosure;

FIG. 15 is a schematic diagram of an electric field of the pixel electrode shown in FIG. 14;

FIG. 16 is a schematic diagram of still another type of liquid crystal rotation in a display panel after a squeezing force is released according to an embodiment of the present disclosure;

FIG. 17 is a schematic structural diagram of a further pixel electrode according to an embodiment of the present disclosure;

FIG. 18 is a schematic diagram of an electric field of the pixel electrode shown in FIG. 17;

FIG. 19 is a schematic diagram of yet another type of liquid crystal rotation in a display panel after a squeezing force is released according to an embodiment of the present disclosure;

FIG. 20 is a schematic structural diagram of a still further pixel electrode according to an embodiment of the present disclosure;

FIG. 21 is a schematic structural diagram of a pixel structure according to an embodiment of the present disclosure;

FIG. 22 is a schematic structural diagram of a display panel according to an embodiment of the present disclosure;

FIG. 23 is a schematic structural diagram of a display apparatus according to an embodiment of the present disclosure;

FIG. 24 is a schematic diagram of a structure of a second electrode according to some embodiments of the present disclosure;

FIG. 25 is a schematic diagram of a structure of another second electrode according to some embodiments of the present disclosure;

FIG. 26 is a comparative diagram of a test with different designs for a second electrode according to some embodiments of the present disclosure;

FIG. 27 is a schematic diagram of a structure of a second electrode in a 1P1D structure according to some embodiments of the present disclosure;

FIG. 28 is a schematic diagram of a structure of a second electrode in a 2P2D structure according to some embodiments of the present disclosure;

FIG. 29 is a schematic diagram of a structure of a second electrode in a 1PD structure according to some embodiments of the present disclosure;

FIG. 30 is a schematic diagram of a structure of another second electrode in a 1P2D structure according to some embodiments of the present disclosure;

FIG. 31 is a schematic diagram of a structure of a display panel according to some embodiments of the present disclosure;

FIG. 32 is a schematic diagram of a structure of another display panel according to some embodiments of the present disclosure; and

FIG. 33 is a schematic diagram of a structure of a display device according to some embodiments of the present disclosure.

### DETAILED DESCRIPTION OF THE EMBODIMENTS

To make the objectives, technical solutions and advantages of the present disclosure clearer, the followings will describe the embodiments of the present disclosure in detail with reference to the drawings.

In the related art, a pixel electrode in a liquid crystal display panel generally includes a plurality of strip-shaped electrodes, a first connection electrode for connecting one end of the plurality of strip electrodes, and a second connection electrode for connecting the other end of the plurality of strip electrodes. Both an extension direction of the first connection electrode and an extension direction of the second connection electrode intersect with an extension direction of the plurality of strip-shaped electrodes.

However, an electric field at a joint of the plurality of strip-shaped electrodes and the connection electrode is relatively disordered. Therefore, when the liquid crystal display panel is squeezed by an external force, arrangement of liquid crystals disposed at the joint of the plurality of strip-shaped electrodes and the connection electrode in the liquid crystal display panel will be relatively disordered, and the LCD panel is prone to trace mura (trace mura).

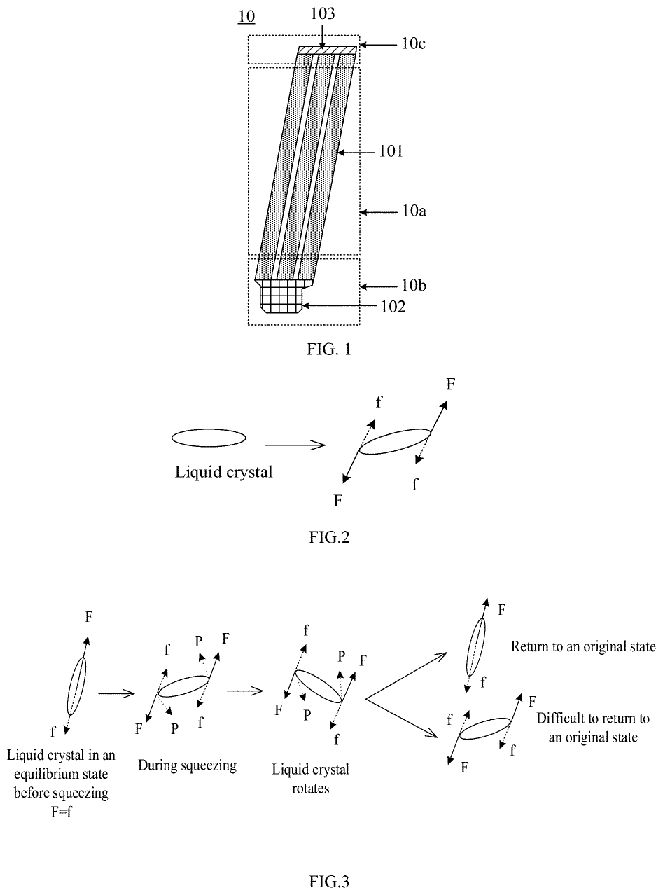

FIG. 1 is a schematic structural diagram of a pixel electrode according to the related art. Referring to FIG. 1, the pixel electrode 10 includes a plurality of first electrodes 101, a second electrode 102 and a third electrode 103. The second electrode 102 is connected to ends at one side of the plurality of first electrodes 101, and the ends at one side of the plurality of first electrodes 101 are connected through the second electrode 102. The third electrode 103 is connected to the other end of each of the plurality of first electrodes 101, and the other ends of the plurality of first electrodes 101 are connected through the second electrode 103. Both ends of the first electrode 101 have no corners.

An electric field of a middle area 10a of the pixel electrode 10 is determined by the first electrode 101. An electric field of a first area 10b of the pixel electrode 10 including the second electrode 102 is determined by both the second electrode 102 and the first electrode 101. An electric field of a second area 10c of the pixel electrode 10 including the third electrode 103 is determined by both the third electrode 103 and the first electrode 101.

The first area 10b of the pixel electrode 10 is used to connect to a pixel circuit in a display panel, so that the pixel circuit provides a driving signal for the pixel electrode. If a common electrode in the display panel is disposed between the pixel electrode and the pixel circuit, the common electrode may be provided with a through hole, so that the pixel electrode is connected to the pixel circuit via the through hole. Since the through hole of the common electrode is disposed in the first area 10b, there may be no electric field or a weak electric field in the first area 10b. Liquid crystals disposed in the first area 10b in the display panel reach equilibrium mainly under an action of an anchoring force of a film disposed at a side of the pixel electrode 10 away from a base substrate.

Since the electric field of the middle area 10a in the pixel electrode 10 is determined by the first electrode 101, liquid crystals in the middle area 10a in the display panel can reach equilibrium under an action of the anchoring force of the film disposed at the side of the pixel electrode 10 away from the base substrate.

Since the common electrode is not provided with a through hole in the second area 10c, an electric field can be generated in an area in which the third electrode 103 and the first electrode 101 are disposed. Liquid crystals disposed in the second area 10c in the display panel can reach equilibrium under an action of the generated electric field around the third electrode 103 and the first electrode 101 and an action of the anchoring force of the film disposed at the side of the pixel electrode 10 away from the base substrate.

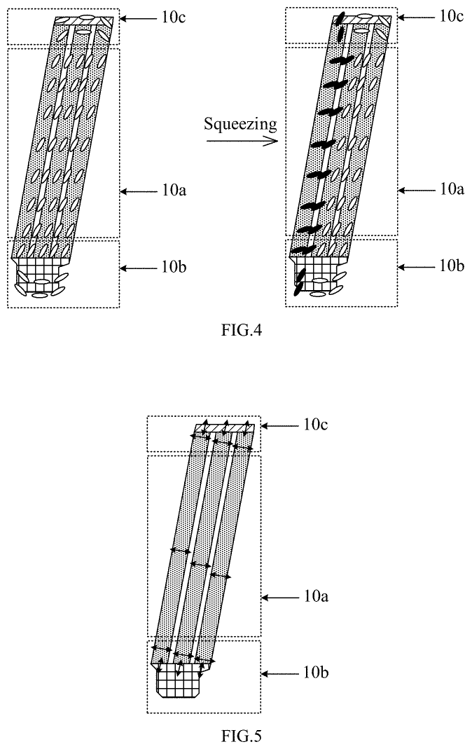

Under a same applied voltage, the stronger the electric field F, the greater rotation angle of the liquid crystal and the stronger anchoring force f of the film disposed at the side of the pixel electrode 10 away from the base substrate. On the contrary, the weaker the electric field F, the smaller rotation angle of the liquid crystal and the weaker anchoring force f of the film disposed at the side of the pixel electrode 10 away from the base substrate. Referring to FIG. 2, when the liquid crystal reaches an equilibrium state, the electric field F is equal to the anchoring force f.

The liquid crystals disposed in the middle area 10a and the liquid crystals disposed in the second area 10c in the pixel electrode 10 in the display panel reach equilibrium under an impact of the electric field. Therefore, it can be analyzed whether the liquid crystals in these two areas can reach equilibrium under an action of the electric field.

Referring to FIG. 3, before the display panel is squeezed by an external force, the electric field F and the anchoring force f received by the pixel electrode 10 may be equal, and the liquid crystals are in an equilibrium state under an action of the electric field F and the anchoring force f. When the display panel is squeezed by an external force, the liquid crystals in the display panel rotate under an action of the electric field F, the anchoring force f, and the squeezing force P. As shown in FIG. 4, the liquid crystals in the middle area 10a, the first area 10b, and the second area 10c in the pixel electrode 10 in the display panel all rotate.

Referring to FIG. 3, since the electric field in the middle area 10a in the pixel electrode 10 is relatively strong, the liquid crystals in the middle area 10a in the display panel can regain an equilibrium state (return to an original state) under the action of the electric field. Since a direction of the electric field of the second area 10c in the pixel electrode 10 is determined based on the first electrode 101 and the third electrode 103 which have different extension directions, the direction of the electric field of the second area 10c in the pixel electrode 10 is more disordered, referring to FIG. 5. Therefore, referring to FIG. 3, arrangement of the liquid crystals in the second area 10c in the display panel is relatively disordered (difficult to return to an original state), which in turns leads to the problem of darkening of local positions on the display panel, that is, trace mura occurs on the display panel.

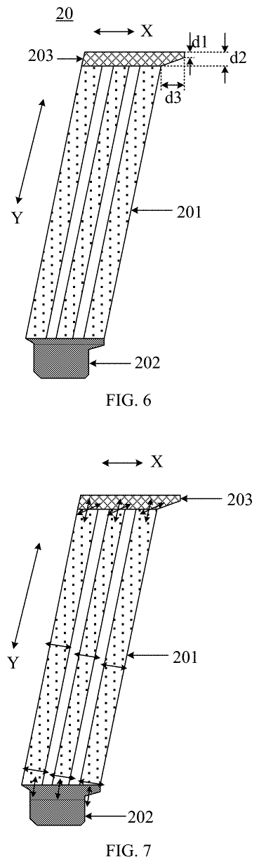

An embodiment of the present disclosure provides a pixel electrode, which can solve a problem in the related art that the display panel is prone to trace mura. Referring to FIG. 6, the pixel electrode 20 may include a plurality of strip-shaped first electrodes 201, a second electrode 202, and a third electrode 203.

The plurality of first electrodes 201 may be arranged along a first direction X, and each first electrode 201 may extend along a second direction Y, and the second direction Y may intersect with the first direction X. For example, the first direction X may be a pixel row direction, and the second direction Y may intersect with both the pixel row direction and a pixel column direction.

The second electrode 202 may be connected to first ends of the plurality of first electrodes 201, and the first ends of the plurality of first electrodes 201 may be connected through the second electrode 202. In other words, each first electrode 201 can be connected to the second electrode 202. The second electrode 202 may be configured to connect to a pixel circuit in the display panel, so that the pixel circuit can provide a driving signal for the pixel electrode through the second electrode 202.

The third electrode 203 may be connected to a second end of at least one first electrode 201, and a direction of an electric field of the area in which the third electrode 203 is located intersects with both the first direction X and the second direction Y. Therefore, referring to FIG. 7, a direction of an electric field at a joint of the second end of the first electrode 201 and the third electrode 203 may be relatively regular.

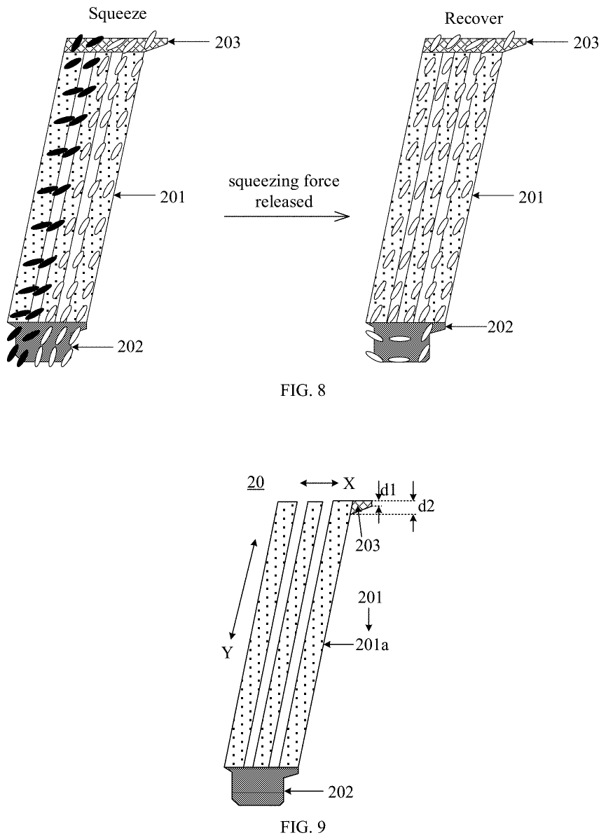

Therefore, referring to FIG. 8, when the display panel is squeezed by an external force, liquid crystals in the first electrode 201, the second electrode 202, and the third electrode 203 in the pixel electrode 20 in the display panel all rotate. After the squeezing force is released, the liquid crystals in the first electrode 201 and the second electrode 202 in the display panel are regularly arranged, and liquid crystals at a joint of the third electrode 203 and the first electrode 201 in the display panel may also be regularly arranged under an action of the electric field formed by the third electrode 203 and the first electrode 201. Trace mura on the display panel can be avoided, and a display effect of the display panel is better.

In summary, the embodiment of the present disclosure provides a pixel electrode. The third electrode included in the pixel electrode is connected to the other end of at least one first electrode, and the direction of the electric field of the area in which the third electrode is located intersects with both the first direction and the second direction. The direction of the electric field formed at the joint of the third electrode and the second end of the first electrode is relatively regular, so that the liquid crystals disposed at the joint of the third electrode and the first electrode in the display panel can be arranged regularly under the action of the electric field. This avoids trace mura on the display panel, and a display effect of the display panel is better.

Optionally, referring to FIG. 6, the plurality of first electrodes 201 are linear, so that orientations of the liquid crystals of the display panel in each area of the plurality of first electrodes 201 are the same. Therefore, the display panel does not have a dark area, and light efficiency of the display panel is higher.

As an optional implementation, the third electrode 203 may extend along the first direction X, and the third electrode 203 may be connected to the second end of at least one first electrode 201, and at least one of a first end and a second end of the third electrode 203 protrudes in a direction away from the plurality of first electrodes 201 relative to second ends of the plurality of first electrodes 201.

Since at least one of the first end and the second end of the third electrode 203 protrudes in the direction away from the plurality of first electrodes 201 relative to the second ends of the plurality of first electrodes, an angle between an extension direction of the first electrode 201 and a direction of a connection line between the second end of the first electrode 201 and a protruding end of the third electrode 203 may be relatively small. The direction of the electric field at the joint of the second end of the first electrode 201 and the third electrode 203 may be relatively regular.

In the embodiment of the present disclosure, the first end of the third electrode 203 may be connected to the second end of at least one first electrode 201, and the second end of the third electrode 203 may protrude in the direction away from the plurality of first electrodes 201 relative to the second ends of the plurality of first electrodes 201.

Referring to FIG. 6, it can be seen that, the first end of the third electrode 203 may be connected to the second end of each first electrode 201. Alternatively, referring to FIG. 9, the first end of the third electrode 203 may be connected to a second end of a first target electrode 201a in the plurality of first electrodes 201, and other first electrodes 201 except the first target electrode 201a in the plurality of first electrodes 201 are all disposed on one side of the first target electrode 201a. In other words, the first target electrode 201a is a first electrode 201 disposed at the edge of the plurality of first electrodes 201.

For example, in FIG. 9, the first target electrode 201 a is the rightmost first electrode in the plurality of first electrodes 201. Certainly, the first target electrode 201a may also be the leftmost first electrode in the plurality of first electrodes 201a.

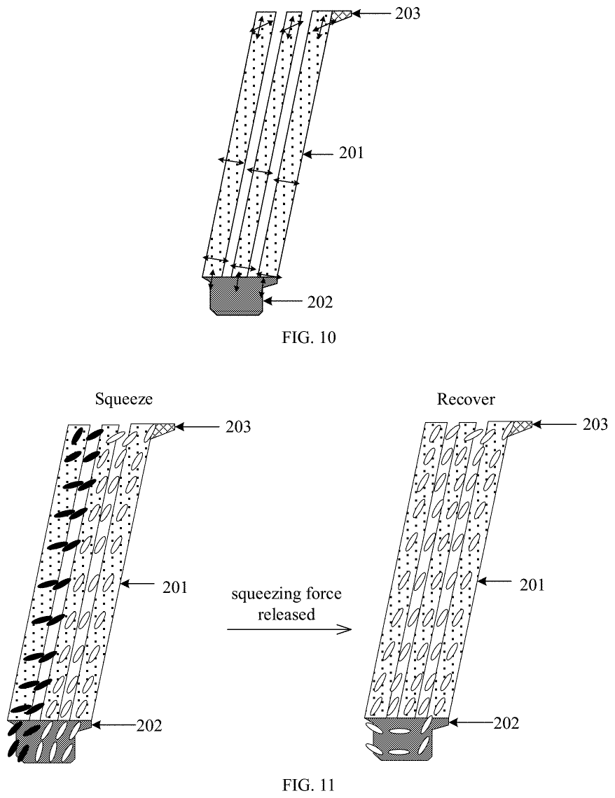

For the pixel electrode 20 in FIGS. 6 and9 described above, a direction of the protruding end of the third electrode 203 in the pixel electrode 20 is the same as a direction of a connection line between the second ends of the plurality of first electrodes 201. Therefore, refer to FIGS. 7 and 10, directions of an electric field formed by the third electrode 203 and the second ends of the plurality of first electrodes 201 are also the same.

Referring to FIGS. 8 and 11, when the display panel is squeezed by an external force, the liquid crystals in the first electrode 201, the second electrode 202, and the third electrode 203 in the pixel electrode 20 in the display panel all rotate. After the squeezing force is released, the liquid crystals at the joint of the third electrode 203 and the first electrode 201 in the display panel may rotate under an action of the electric field formed by the third electrode 203 and the second ends of the first electrode 201. Since the directions of the electric field formed by the third electrode 203 and the second ends of the plurality of first electrodes 201 are the same, the liquid crystals disposed at the joint of the third electrode 203 and the first electrode 201 in the display panel can arrange in a same direction under an action of the electric field, so that a display effect of the display panel is better.

In the embodiment of the present disclosure, the number of arrangement directions of the liquid crystals disposed at the joint of the third electrode 203 and the first electrode 201 in the display panel may be positively related to the number of directions of the electric field formed by the third electrode 203 and the second ends of the plurality of first electrodes 201. In addition, the smaller the number of the arrangement directions of the liquid crystals disposed at the joint of the third electrode 203 and the first electrode 201 in the display panel, the more regular, the arrangement of the liquid crystals. In other words, the smaller the number of the directions of the electric field formed by the third electrode 203 and the second ends of the plurality of first electrodes 201, the more regular the arrangement of the liquid crystals disposed at the joint of the third electrode 203 and the first electrode 201 in the display panel. In this way, a display effect of the display panel is better.

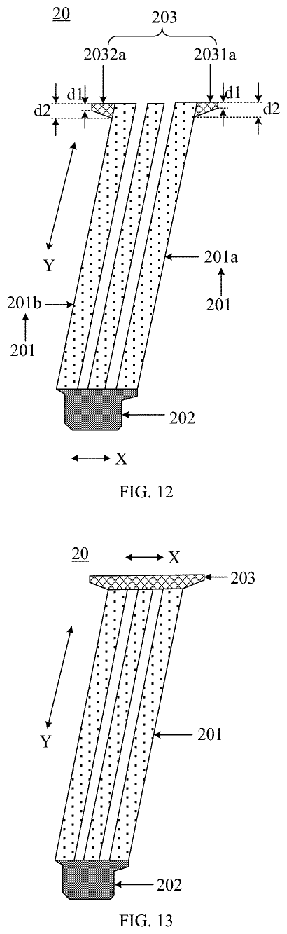

FIG. 12 is a schematic structural diagram of still another pixel electrode according to an embodiment of the present disclosure. Referring to FIG. 12, it can be seen that, the third electrode 203 may include a first sub-electrode 2031a and a second sub-electrode 2032a. A first end of the first sub-electrode 2031a may be connected to a second end of a first target electrode 201a in the plurality of first electrodes 201, and a second end of the first sub-electrode 2031a protrudes in a direction away from the plurality of first electrodes 201 relative to the second end of the first target electrode 201a. A first end of the second sub-electrode 2032a may be connected to a second end of a second target electrode 201b in the plurality of first electrodes 201, and a second end of the second sub-electrode 2032a protrudes in a direction away from the plurality of first electrodes 201 relative to the second end of the second target electrode 201b.

Other first electrodes except the first target electrode 201a in the plurality of first electrodes 201 may all be disposed on one side of the first target electrode 201a. Other first electrodes except the second target electrode 201b in plurality of first electrodes 201 may all be disposed on one side of the second target electrode 201b. In other words, the first target electrode 201a and the second target electrode 201b may be first electrodes 201 that are disposed at two edges of the plurality of first electrodes 201. For example, referring to FIG. 12, the first target electrode 201a is the rightmost first electrode in the plurality of first electrodes 201, and the second target electrode 201b is the leftmost first electrode in the plurality of first electrodes 201.

For the pixel electrode 20 shown in FIG. 12, a direction of a connection line between the first sub-electrode 2031a and the second end of the first target electrode 201a is different from a direction of a connection line between the second sub-electrode 2032a and the second end of the second target electrode 201b. Therefore, a direction of an electric field formed by the first sub-electrode 2031a and the second end of the first target electrode 201a is different from a direction of an electric field formed by the second sub-electrode 2032a and the second end of the second target electrode 201b. Therefore, an arrangement direction of liquid crystals disposed at a joint of the first sub-electrode 2031a and the second end of the first target electrode 201a in the display panel may be different from an arrangement direction of liquid crystals disposed at a joint of the second sub-electrode 2032a and the second end of the second target electrode 201b in the display panel.

However, the number of directions of the electric field formed by the third electrode 203 and the second ends of the plurality of first electrodes 201 is small. Therefore, the liquid crystals disposed at the joint of the third electrode 203 and the first electrode 201 in the display panel are more regularly arranged after the squeezing force is released, so that a display effect of the display panel is better.

FIG. 13 is a schematic structural diagram of yet another pixel electrode according to an embodiment of the present disclosure. Referring to FIG.13, it can be seen that, the third electrode 203 may be connected to a second end of each first electrode 201, and a first end and a second end of the third electrode 203 protrude in a direction away from a plurality of first electrodes 201 relative to second ends of the plurality of first electrodes 201.

Since directions of connection lines between two protruding ends of the third electrode 203 and the second ends of the plurality of first electrodes 201 are different, directions of electric fields formed by the two protruding ends of the third electrode 203 and the second ends of the plurality of first electrodes 201 are different. For the pixel electrode 20 shown in FIG. 13, numbers of directions of the electric fields formed by the third electrode 203 and the second ends of the plurality of first electrodes 201 are also small, and a display effect of the display panel is better.

In addition, since the electric fields formed by the two protruding ends of the third electrode 203 and the second ends of the plurality of first electrodes 201 have different directions, arrangement directions of liquid crystals disposed at the two ends of the third electrode 203 in the display panel are different.

Referring to FIG. 6, FIG. 9, FIG. 12, and FIG. 13, a shape of a protruding end of the third electrode 203 may be a trapezoid or a triangle. A width d1 of a side, which is away from the plurality of first electrodes 201, of the protruding end of the third electrode 203 may be smaller than a width d2 of a side, which is closer to the plurality of first electrodes 201, of the protruding end of the third electrode 203. Certainly, the protruding end of the third electrode 203 may alternatively be of another shape, which is not limited in the embodiment of the present disclosure.

In the embodiment of the present disclosure, referring to FIG. 6, the electric field formed by the third electrode 203 and the second ends of the plurality of first electrodes 201 is determined jointly by a distance d3 between the protruding end of the third electrode 203 and the plurality of first electrodes 201, and the width d2 of the side, which is closer to the plurality of first electrodes 201, of the protruding end of the third electrode. Further, the distance d3 between the protruding end of the third electrode 203 and the plurality of first electrodes 201 correlates with the width d2 of the side, which is closer to the plurality of first electrodes 201, of the protruding end of the third electrode.

Optionally, when the width d2 of the side, which is closer to the plurality of first 6electrodes 201, of the protruding end of the third electrode 203 is less than or equal to 2.5 μm, and the distance d3 between the protruding end of the third electrode 203 and the plurality of first electrodes 201 is greater than or equal to 1.2 μm, trace mura does not exist on the display panel. When the width d2 of the side, which is closer to the plurality of first electrodes 201, of the protruding end of the third electrode is greater than 2.5 μm and less than or equal to 3.5 μm, and the distance d3 between the protruding end of the third electrode 203 and the plurality of first electrodes 201 is greater than or equal to 1.87 μm, trace mura does not exist on the display panel. When the width d2 of the side, which is closer to the plurality of first electrodes 201, of the protruding end of the third electrode is greater than 3.5 μm and less than or equal to 4.5 μm, and the distance d3 between the protruding end of the third electrode 203 and the plurality of first electrodes 201 is greater than or equal to 3.3 μm, trace mura does not exist on the display panel.

In other words, to avoid trace mura on the display panel, the following conditions need to be met: d2≤2.5 μm, and d3≥1.2 μm; 2.5 μ<d2≤3.5 μm, and d3≥1.87 μm; or 3.5 μm<d2≤4.5 μm, and d3≥3.3 μm.

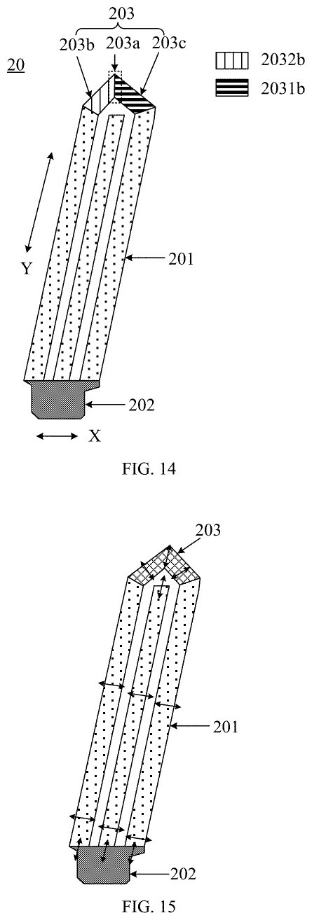

As another optional implementation, referring to FIG. 14, an extension direction of the third electrode 203 may intersect with both the first direction X and the second direction Y, the first end of the third electrode 203 may be connected to one second end of the first electrode 201, and there may be at most one bent portion 203a between the first end and the other end of the third electrode 203.

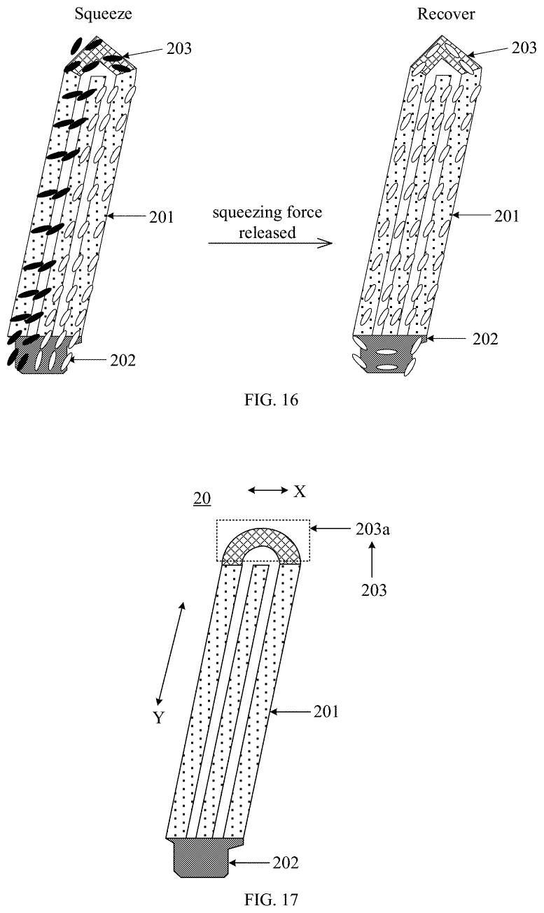

Since there is at most one bent portion 203a between the first end and the second end of the third electrode 203, angles between parts of the third electrode 203 disposed on both sides of the bent portion 203a and the extension direction of the first electrode 201 may both be smaller. Referring to FIG. 15, a direction of an electric field at a joint of the second end of the first electrode 201 and the third electrode 203 may be relatively regular. Therefore, referring to FIG. 16, when the display panel is squeezed by an external force, liquid crystals in the first electrode 201, the second electrode 202, and the third electrode 203 in the pixel electrode 20 in the display panel all rotate. After the squeezing force is released, the liquid crystals in the first electrode 201 and the second electrode 202 in the display panel are regularly arranged, and liquid crystals at a joint of the third electrode 203 and the first electrode 201 in the display panel may also be regularly arranged under a joint action of the third electrode 203 and the first electrode 201. This avoids trace mura on the display panel, and a display effect of the display panel is better.

Optionally, referring to FIG. 16, after the squeezing force is released, because the third electrode 203 is provided with the bent portion 203a, arrangement directions of liquid crystals on the two sides of the bent position 203a of the third electrode 203 are different, while arrangement directions of liquid crystals disposed on a same side of the bent portion 203a are the same. In other words, the liquid crystals disposed on the same side of the bent portion 203a are regularly arranged. The third electrode 203 has at most one bent portion 203a, which can make the liquid crystals disposed at the joint of the third electrode 203 and the first electrode 201 have at most two arrangement directions. This avoids trace mura on the display panel, and a display effect of the display panel is better.

Referring to FIG. 14, both a first part 203b between the first end of the third electrode 203 and the bent portion 203a and a second part 203c between the second end of the third electrode 203 and the bent portion 203a may be of a strip structure, and an extension direction of the first part 203b intersects with an extension direction of the second part 203c. Referring to FIG. 14, the pixel electrode 20 may be pencil-shaped.

As can be further seen from FIG. 14, the third electrode 203 may include a strip-shaped third sub-electrode 2031b and a strip-shaped fourth sub-electrode 2032b, and an extension direction of the third sub-electrode 2031b may intersect with an extension direction of the fourth sub-electrode 2032b.

One end of the third sub-electrode 2031b may be connected to a second end of one first electrode 201. The other end of the third sub-electrode 2031b may be connected to one end of the fourth sub-electrode 2032b, and the other end of the third sub-electrode 2031b and the one end of the fourth sub-electrode 2032b form the bent portion 203a. The other end of the fourth sub-electrode 2032b may be connected to a second end of another first electrode 201. The one end of the third sub-electrode 2031b is the first end of the third electrode 203, and the other end of the fourth sub-electrode 2032b is the second end of the third electrode 203.

FIG. 17 is a schematic structural diagram of a further pixel electrode according to an embodiment of the present disclosure. As can be seen from FIG. 17, the bent portion 203a may be arc-shaped. For example, the third electrode 203 may be an arc-shaped electrode.

Referring to FIG. 14 and FIG. 17, the first end of the third electrode 203 may be connected to a second end of one first electrode 201, and the second end of the third electrode 203 may be connected to a second end of another first electrode 201. In other words, each of the two ends of the third electrode 203is connected to one first electrode 201.

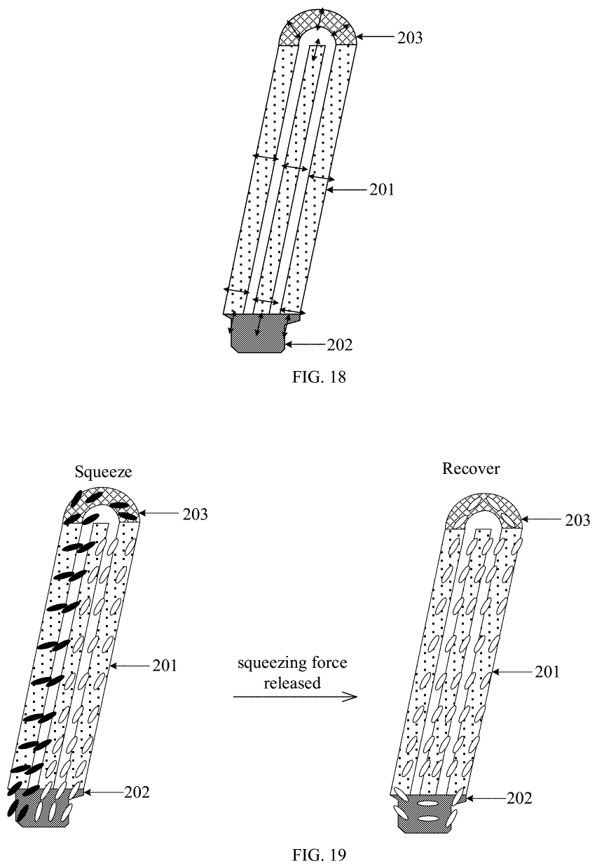

FIG. 18 is a schematic diagram of an electric field of the pixel electrode shown in FIG. 17. As can be seen from FIG. 18, a direction of an electric field at a joint of the second end of the first electrode 201 and the third electrode 203 in the pixel electrode shown in FIG. 17 is relatively regular. Referring to FIG. 19, when the display panel is squeezed by an external force, liquid crystals in the first electrode 201, the second electrode 202, and the third electrode 203 in the pixel electrode 20 in the display panel all rotate. After the squeezing force is released, the liquid crystals in the first electrode 201 and the second electrode 202 in the display panel are regularly arranged, and the liquid crystals at the joint of the third electrode 203 and the first electrode 201 in the display panel may also be regularly arranged under a joint action of the third electrode 203 and the first electrode 201. This avoids trace mura on the display panel, and a display effect of the display panel is better.

In the embodiment of the present disclosure, there may be three or more first electrodes 201 in the pixel electrode 20. Then, other first electrodes in the plurality of first electrodes 201 except the two first electrodes 201 connected to the first end and the second end of the third electrode 203 may all be disposed between the two first electrodes 201. In other words, the two first electrodes 201 connected to the first end and the second end of the third electrode 203 may be two first electrodes 201 disposed at the edges of the plurality of first electrodes 201 respectively.

If there are three first electrodes 201 in the pixel electrode, the plurality of first electrodes 201 may include one other first electrode. If there are more than three first electrodes 201 in the pixel electrode 20, the plurality of first electrodes 201 may include a plurality of other first electrodes.

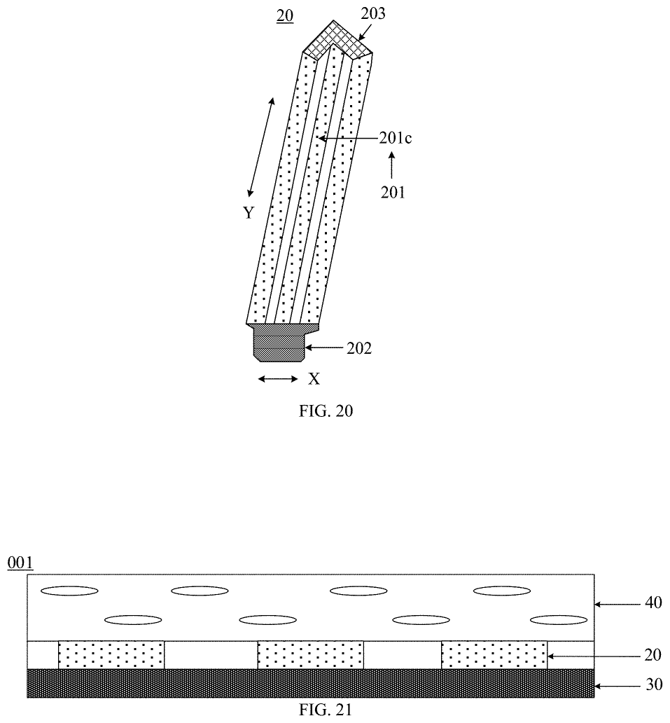

FIG. 20 is a schematic structural diagram of a still further pixel electrode according to an embodiment of the present disclosure. As can be seen from FIG. 20, the other end of at least one other first electrode 201c may be connected to a middle part of the third electrode 203, and the middle part of the third electrode 203 may be disposed between the first end and the second end of the third electrode 203. A length of the other first electrode 201c is greater than lengths of the first electrodes 201 to which the first end and the second end of the third electrode 203 are respectively connected.

In summary, the embodiment of the present disclosure provides a pixel electrode. The third electrode included in the pixel electrode is connected to the other end of at least one first electrode, and the direction of the electric field of the area in which the third electrode is located intersects with both the first direction and the second direction. The direction of the electric field formed at the joint of the third electrode and the second end of the first electrode is relatively regular, so that the liquid crystals disposed at the joint of the third electrode and the first electrode in the display panel can be arranged regularly under the action of the electric field. This avoids trace mura on the display panel, and a display effect of the display panel is better.

FIG. 21 is a schematic structural diagram of a pixel structure according to an embodiment of the present disclosure. As can be seen from FIG. 21, a pixel structure 001 may include a common electrode 30, a liquid crystal layer 40, and the pixel electrode 20 provided in the foregoing embodiment. The common electrode 30 and the pixel electrode 20 can be configured to drive a liquid crystal in the liquid crystal layer 40 to rotate.

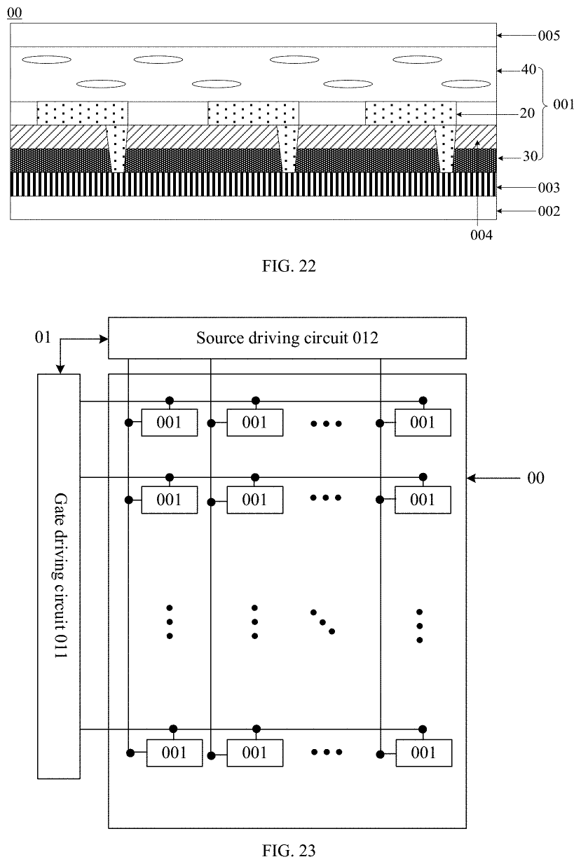

FIG. 22 is a schematic structural diagram of a display panel according to an embodiment of the present disclosure. A display panel 00 may include a base substrate 002 and a plurality of pixel structures 001 disposed on the base substrate 002 which are provided in the foregoing embodiments.

As can further be seen from FIG. 22, the display panel 00 may further include a pixel circuit 003 and a passivation layer 004. The pixel circuit 003, and a common electrode 30, the passivation layer 004, a pixel electrode 20 and a liquid crystal layer 40 in the pixel structure 003 may be stacked on a side away from the base substrate 002.

The common electrode 30 may be provided with a first through hole, the passivation layer 004 may be provided with a second through hole communicating with the first through hole, and a second electrode 202 in the pixel electrode 20 may be connected to the pixel circuit 003 via the first through hole and the second through hole.

The pixel circuit 003 may include a transistor. A gate of the transistor may be connected to a gate line, a source of the transistor may be connected to a data line, and a drain of the transistor may be connected to the pixel electrode 20. For example, the drain of the transistor may be connected to the second electrode 202 in the pixel electrode 20.

Referring to FIG. 22, the display panel 00 may further include a color film substrate 005. The color film substrate 005 may be disposed on a side of the pixel structure 001 away from the base substrate 002. The color film substrate 005 may be configured to convert light into colored light.

FIG. 23 is a schematic structural diagram of a display apparatus according to an embodiment of the present disclosure. As can be seen from FIG. 23, the display apparatus may include a driving circuit 01 and the display panel 00 described in the foregoing embodiment. The driving circuit 01 may be configured to provide a driving signal for a pixel structure 001 in the display panel 00.

Referring to FIG. 23, the driving circuit 01 may include a gate driving circuit 011 and a source driving circuit 012. The gate driving circuit 011 may be connected to each row of pixel structures 001 in the display panel 00 through gate lines, and configured to provide gate driving signals for each row of pixel structures 001. The source driving circuit 012 may be connected to each column of the pixel structures 001 in the display panel 00 through data lines, and is used to provide data signals for each column of pixel structures 001.

Optionally, the display apparatus may be any product or component with a display function, such as a liquid crystal display apparatus, electronic paper, a mobile phone, a tablet computer, a TV, a display, a notebook computer, a digital photo frame, or a navigator.

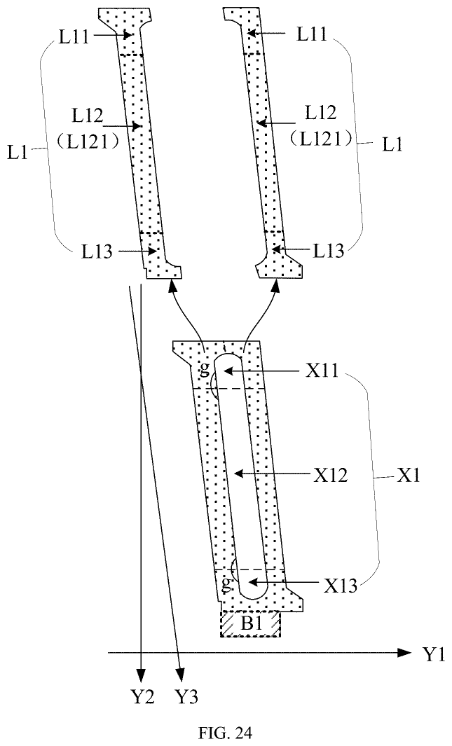

Then referring to FIG. 24, the second electrode 02 (i.e., the electrode of the first electrode 01 and the second electrode 02 near the liquid crystal layer 03) in embodiments of the present disclosure may include a plurality of electrode branches L1

The plurality of electrode branches L1 are arranged sequentially in a first direction Y1. Each of the electrode branches L1 includes a first end portion L11, a body portion L12, and a second end portion L13 that are successively connected in a second direction Y2. The body portion L12 includes at least one body segment L121, and an extension direction of each of the body segments L121, an extension direction of the first end portion L11, and a second end portion L113 are intersected with the second direction Y2, and the second direction Y2 is perpendicular to the first direction Y1. Taking the row direction of the plurality of pixel structures arranged in the array as a reference, the first direction Y1 may refer to the pixel row direction and the second direction Y2 may refer to the pixel column direction, In addition, the first end portions L11 of the plurality of electrode branches L1 are communicated with each other, and the second end portions L13 of the plurality of electrode branches L1 are communicated with each other. The first end portions L11 of at least two electrode brandies L1 are communicated with each other in an arc, and the second end portions L13 of at least two electrode branches L1 communicated with each other in an arc.

For example, the second electrode 02 illustrated in FIG. 24 includes two electrode branches L1, each including one body segment L121 in the body portion L12 of the electrode branch L1, and the extending direction of the body portion L12, the extending direction of the first end portion L11 and the extending direction of the second end portion L13 are the same (the third direction Y3 shown in FIG. 24), intersecting the second direction Y2. The first end portions L11 of the two electrode branches L1 are communicated with each other in an arc and the second end portions L13 of the two electrode branches L1 are communicated with each other in an arc. Referring to FIG. 24, the connection being in an arc may indicate the arc protruding in a direction away from the body portion L12. In some embodiments, the arc may also indicate that the arc is concaved in a direction away from the body portion L12.

Based on the above structure, it can be seen in FIG. 24 that each of the two adjacent electrode branches L1 may have a slit X1 disposed between them, which is an interval between each of the two adjacent electrode branches L1. In other words, a plurality of electrode branches L1 in the second electrode 02 are actually arranged sequentially spaced in the first direction Y1. The slit X1 includes a first slit segment X11, a second slit segment X12 and a third slit segment X13 that are successively connected in the second direction Y2. in conjunction with the structure of the electrode branch L1, it can be seen that the first slit segment X11 can be considered as a slit between the first end portions L11 of every two adjacent electrode branches L1, i.e., close to the first end portion L11 of the electrode branch L1 and having the same structure and extending direction as the first end portion L11. The second slit segment X12 can be considered as a slit between the body portion L12 of each of the two adjacent electrode branches L1, i.e., dose to the body portion L12 of the electrode branch L1, and having the same structure and extending direction as the body portion L12. The third slit segment X13 may be considered to be a slit between the second end portion L13 of each of the two adjacent electrode branches L1, i.e., close to the second end portion L13 of the electrode branch L1, and having the same structure and extending direction as the second end portion L13.

it should also be noted that, in the second direction Y2, the length of the first end portion L11 and the length of the second end portion L13 of the electrode branch L1 are both smaller than the length of the body portion L12. Accordingly, the length of the first slit segment X11 and the length of the third slit segment X13 are both smaller than the length of the second slit segment X12.

Referring to FIG. 24, in the embodiments of the present disclosure, an angle g between at least one of the first slit segment X11 and the third slit segment X13 and the second slit segment X12 is equal to 180 degrees. For example, in the second electrode 02 illustrated in FIG. 24, the angle g between the first slit segment X11 and the second slit segment X12, and the angle g between the third slit segment X13 and the second slit segment X12 are both equal to 180 degrees.

Based on the above embodiment, it can be seen that the angle g equal to 180 degrees between the first slit segment X11 and the second slit segment X12 can be equivalent to that the communication of the first end portions L11 of each of the two adjacent electrode branches L1 does not have an inner corner. Referring to FG. 24, the inner corner can be referred to as the upper inner corner. Similarly, the angle g between the third slit segment X13 and the second slit segment X12 equal to 180 degrees can be equivalent to that the communication of the second end portions L13 of each of the adjacent electrode branches L1 does not have an inner corner. Referring to FIG. 24, the inner corner can be referred to as the lower inner corner. In other words, the disclosed embodiment eliminates the upper inner corner and/or the lower inner corner to effectively ensure that both the transmittance and contrast of the display panel can be better. Based on this, the electrode branches can be designed to improve the Trace Mura problem and ensure better display quality of the display panel. The specific design of the electrode branches can be described in the following examples.

in summary, embodiments of the present disclosure provide a pixel structure. The pixel structure includes a first electrode, a second electrode, and a liquid-crystal layer disposed on one side of a substrate and successively stacked. The second electrode includes a plurality of electrode branches arranged sequentially in the first direction, and each of the two adjacent electrode branches have slits between them. In the second direction intersecting the first direction, each of the electrode branches includes a first end portion, a body portion and a second end portion, and the slit includes a first slit segment, a second slit segment and a third slit segment, and the first end portions of the plurality of electrode branches are communicated with each other, and the second end portions are communicated with each other. Because the angle between the first slit segment and/or the third slit segment and the second slit segment is equal to 180 degrees, it is possible to make the communication of the first end portions and/or the communication of the second end portions of each of the two adjacent electrode branches do not have inner corners, In this way, the transmittance of the display panel can be made better. Based on this, the shape of the electrode branches can be flexibly set to improve the Trace Mura problem and a better display quality of the display panel is ensured.

Optionally, the following embodiment of the present disclosure is illustrated with the first electrode 01 as a common electrode and the second electrode 02 as a pixel electrode. That is, the embodiments of the present disclosure may be an improvement to the structure of the pixel electrode so as to ensure a better transmittance and contrast of the display panel while also effectively and reliably improving the Trace Mura problem that is common in the display panel. In the case that the second electrode 02 is a common electrode, it can be considered that the present disclosure embodiment is an improvement of the structure of the common electrode.

It should be noted that, with reference to FIG. 2, the first electrode 01 is generally provided on the substrate 10 as a whole layer, while the second electrode 02 generally includes a plurality of electrode patterns arranged at intervals, and the improvement of the second electrode 02 in the embodiment of the present disclosure can be considered as an improvement of the individual electrode patterns in the second electrode 02.

Optionally, the pixel structure in embodiments of the present disclosure may also include a thin film transistor (TFT), And, with continued reference to FIG. 24, the second electrode 02 may also include a connection portion B1.

The thin film transistor TFT may be connected to the second end portion L13 of the plurality of electrode branches L1 through the connection portion 131 and is configured to supply a voltage to the plurality of electrode branches L1. For example, the supplied voltage may be a pixel voltage Vop to drive the deflection of the liquid-crystal molecules. The electric field formed by the common electrode and the pixel electrode described above may refer to an electric field formed by the pressure difference between that pixel voltage Vop and the common voltage Vcom. The common voltage Vcom is the voltage loaded to the common electrode. The thin film transistor TFT that supplies the voltage may be part of the pixel circuit.

Accordingly, based on the above connection, it is known that in the disclosed embodiment, the second end portion L13 of the electrode branch L1 may be considered to be the side where the TFT is disposed, and the first end portion L11 of the electrode branch L1 may be considered to be the opposite side of the side where the TFT is disposed, thereby further achieving a distinction between the first end portion L11 and the second end portion L13.

Optionally, the substrate 10 may be generally divided into a plurality of pixel domains arranged in an array, and the display panel may include a plurality of pixel structures, and the second electrode 02 in a pixel structure may occupy two adjacent pixel domains disposed in the same column, and the pixel structures may also be referred to as 1P2D two-domain pixel structures. Alternatively, the second electrode 02 in a pixel structure may occupy only one pixel domain, and the type of pixel structure may also be referred to as a single-domain pixel structure. That is, the pixel structure can usually be divided into various structure types such as double-domain and single-domain, and the embodiments of the present disclosure have different designs for different types of electrode branches in the pixel structure as follows, thereby reliably improving the Trace Mura problem of display panels including various types of pixel structures.

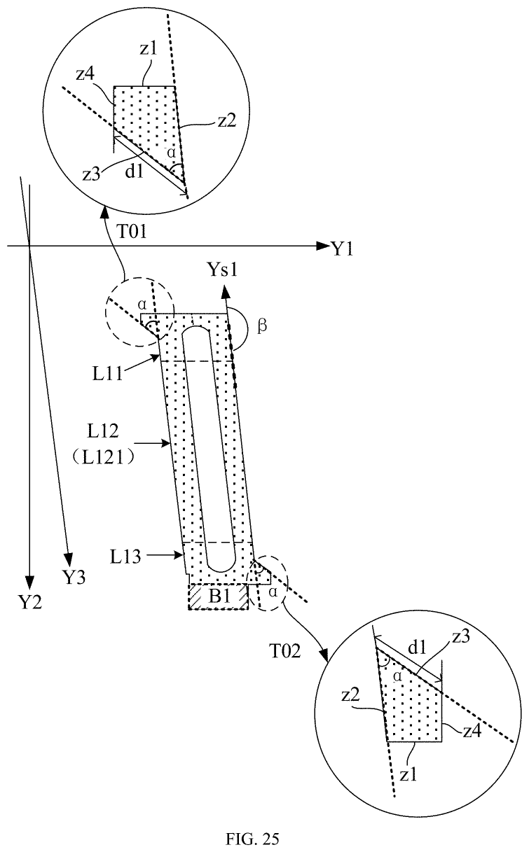

As an optional implementation, for the single-domain pixel structure, it can be seen in the FIG. 24 and FIG. 25 that the body portion L12 of each of the plurality of electrode branches L1 may have only one body segment L121, and the extending direction of the body segment L121, the extending direction of the first end portion L11, and the extending direction of the second end portion L13 are all the third direction shown in FIG. In other words, the body portions L12 of the plurality of electrode branches L1 may be parallel to each other.

Based on this, one end of the first end portion L11 in the first target electrode branch of the plurality of electrode branches L1 may protrude in a direction away from remaining electrode branches L1 except the first target electrode branch. That is, the first target electrode branch may have a first protrusion 101 as shown in FIG. 25, and the first protrusion 101 may also be referred to as an upper outer corner disposed on the opposite side of the side where the TFT is disposed.

The first target electrode branch is the outermost electrode branch of the plurality of electrode branches L1, and the protruding direction of the first end portion L11 of the first target electrode branch is a same direction as an inclining direction of the first end portion L11, i.e., in exactly the same direction. The inclining direction of the first end portion L11 may refer to the direction in which the first end portion L11 inclines toward the side distal from the body portion L12. In this way, the end of the first target electrode branch in which the first end portion L11 protrudes is the end that is not connected to the first end portion L11 of the remaining electrode branch L1. For the pixel structure shown in FIG. 25, the first target electrode branch is the first electrode branch L1 disposed on the left side of the two electrode branches L1 included in the second electrode 02, and belongs to the first electrode branch L1 arranged in the first direction Y1.

By setting the first end portion L11 of the first target electrode branch to have a first protrusion T01 protruding in the above direction, i.e., by setting the second electrode 02 to also have an upper outer corner, the liquid-crystal molecules disposed at the position (i.e., the upper region described in the above embodiment) can also be quickly deflected back to the equilibrium state under the action of the electric field, such that the liquid-crystal molecules at remaining positions can be released for the arrangement state of the remaining positions. The liquid-crystal molecules at the remaining positions are quickly deflected back to the equilibrium state, thus avoiding the disorder of the liquid-crystal molecules and improving the Trace Mura problem.

Referring to FIG. 25 again, in the plurality of electrode branches L1 describes in the disclosed embodiment, one end of the second end portion L13 in the second target electrode branch may protrude in a direction away from the remaining electrode branches L1 except the second target electrode branch, That is, the second target electrode branch may have a second protrusion 102 shown in FIG. 25, and the second protrusion 102 may also be referred to as an outer corner of the lower end disposed on the side where the TFT is disposed.

The second target electrode branch is another outermost electrode branch of the plurality of electrode branches L1, and a protruding direction of the second end portion L13 of the second target electrode branch is in a same direction as an inclining direction of the second end portion L13, i.e., in exactly the same direction. The inclining direction of the second end portion L13 may also refer to the direction in which the second end portion L13 inclines toward the side distal from the body portion L12. In this way, the end of the second target electrode branch in which the second end portion L13 protrudes is the end that is not connected to the second end portion L13 of the remaining electrode branch L1. For the structure shown in FIG. 25, the second target electrode branch is the electrode branch L1 on the right side of the two electrode branches L1 included in the second electrode 02, which is the last electrode branch L1 arranged in the first direction Y1. It should be noted that the inclining direction of the first end portion L11 and the inclining direction of the second end portion L13 can also be referred to the slit inclining direction, or the slit direction for short,

As setting the first protrusion T01 described above, by setting the second end portion L13 of the second target electrode branch to have the second protrusion T02 protruding in the above direction, by setting the second electrode 02 to also have a lower outer corner, the liquid-crystal molecules disposed at this position (i.e., the lower end described in the above embodiment) can also be quickly deflected back to the equilibrium state, such that the liquid-crystal molecules at the remaining positions can be released for the arrangement state of the remaining positions. The liquid-crystal molecules at the remaining positions are quickly deflected back to the equilibrium state, thus avoiding the disorder of the liquid-crystal molecules and improving the Trace Mura problem.

Because the second end portion L13 of the electrode branch L1 (i.e., the side where the TFT is disposed) has a more complicated structure, it is also possible to set only the first end portion L11 of the first target electrode branch (i.e., the opposite side of the side where the TFT is disposed) to have an outer corner to improve the Trace Mura problem.

Optionally, referring to the enlarged schematic diagrams of the first protrusion T01 and the second protrusion T02 shown in FIG. 25, it can be seen that a shape of a protruding end of the first target electrode branch (i.e., the first protrusion T01) and the shape of a protruding end of the second target electrode branch (i,e., the second protrusion T02) can both include a first edge z1, a second edge z2, a third edge z3, and a fourth edge z4 that are successively connected.

Refuting to FIG. 25, a first edge z1 may extend in the first direction Y1. The second edge z2 may extend in the third direction Y3. An extending direction of the third edge z3 may be intersected with the third direction Y3 at an angle α greater than or equal to 45 degrees. Because the second edge z2 extends in the third direction Y3, the angle α may be the angle between the second edge z2 and the third edge z3, and the angle α is oriented close to the first edge z1. The length d1 of the third edge z3 may be greater than or equal to (≥) 2 μm. The fourth edge z4 may extend in a direction intersecting the extending direction of the third edge.

Optionally, the shape of the first edge z1, the second edge z2, the third edge z3, and the fourth edge z4 that are successively connected may be a trapezoid as shown in FIG. 25. Alternatively, in some other embodiments, it may be other shapes, such as an irregular quadrilateral with the fourth edge z4 being curved.

Optionally, in embodiments of the present disclosure, the angle α between the extending direction of the third edge z3 and the third direction Y3 can be equal to 45 degrees or 60 degrees. That is, the angle between the second edge z2 and the second edge z3 is equal to 45 degrees or 60 degrees.

Optionally, in embodiments of the present disclosure, the length d1 of the third edge z3 may be less than or equal to 5 μm m addition to greater than or equal to 2 μm. Considering process limitation effects, the length d1 of the third edge z3 may preferably be greater than or equal to 3 μm.

It has been tested and verified that by setting the angle α, between the second edge z2 and the second edge z3 equal to 45 degrees or 60 degrees, and/or, setting the length d1 of the third edge z3 greater than or equal to 3 microns, the Trace Mura problem can be effectively solved while ensuring the maximum transmittance, thus reliably improving the display quality of the display panel.

In some other embodiments, the shape of the protruding end of the first target electrode branch (i.e., the first protrusion T01) and the shape of the protruding end of the second target electrode branch (i.e., the second protrusion T02) may also be triangular. For example, referring to FIG. 25, the fourth edge z4 does not exist and the third edge z3 is directly connected to the first edge z1.

Optionally, as can be seen with continued reference to FIG. 25, in the embodiment of the present disclosure, the angle β between the extending direction Ys1 and the third direction Y3 in the first end portion L11 of the second target electrode branch (e.g., the electrode branch L1 disposed on the right side in the structure shown in FIG. 25) distal from the end of the electrode branch L1 expect the second target electrode branch may be less than or equal to 180 degrees. Because the body portion L12 of the electrode branch L1 extends in the third direction Y3, the angle β can also be considered as the angle between the extending direction Ys1 and the extending direction of the body portion L12.

For example, referring to FIG. 25 which illustrates an angle β equal to 180 degrees, it can be considered that the end of the first end portion L11 of the second target electrode branch, which is distal from the remaining electrode branches L1 expect the second target electrode branch, is parallel to the slit direction. Similarly, in the case that the angle β is less than 180 degrees, it can be considered that the end of the first end portion L11 of the second target electrode branch, which is distal from the remaining electrode branches except the second target electrode branch, is at an acute angle to the slit direction, In this way, the Trace Mura problem of the display panel can be further reliably avoided.

It should be noted that, referring to FIG. 25, the above design can be understood as follows. Among the outermost two electrode branches L1 included in the plurality of electrode branches L1, only the first end portion L11 of one electrode branch L1 has a protruding outer corner, while the first end portion L11 of the other electrode branch does not have an outer corner. The second end portion L13 is identical and is not repeated herein.

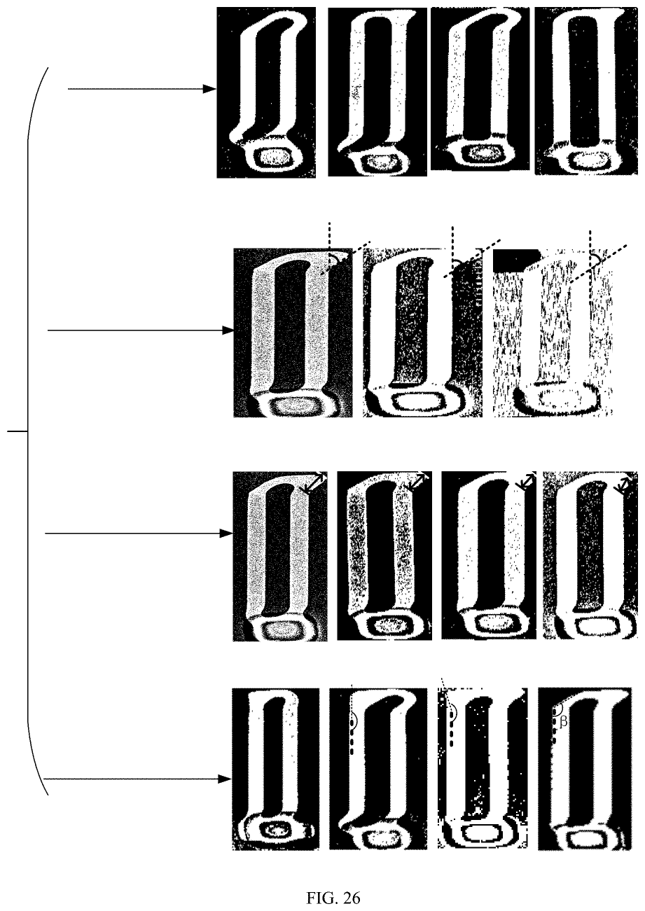

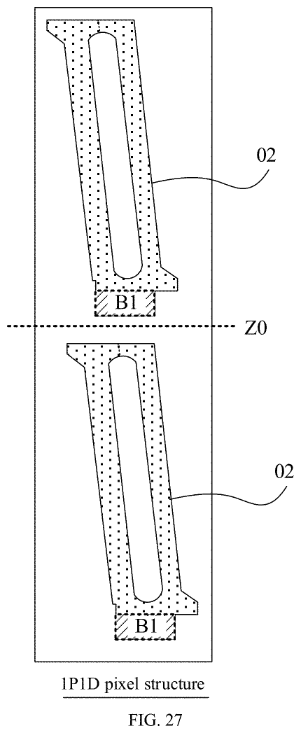

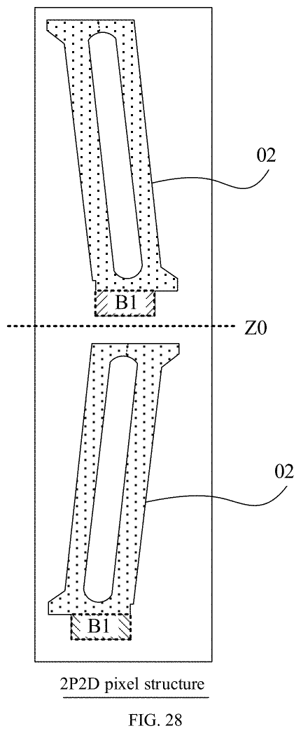

The above designs regarding the parameters of the embodiments are reliably acquired by validation and test. In the validation, 4 groups of influence factors can be applied to verify each of them. Referring to FIG. 5, these four groups of influence factors can include (1) inner corner design, (2) outer corner angle (i.e., angle α) design, (3) outer corner length (i.e., length of the third edge z3) design, and (4) outer corner direction design. FIG. 26 shows the comparison graphs under each group of influence factors. “OK” indicates Trace can be eliminated and “NG” indicates Trace cannot be eliminated and the design fails.

Referring to the comparison the influence factor of group (1) in FIG. 26, it can be seen that for the above single-domain pixel structure, the transmittance can be improved by eliminating the upper inner corner and/or the lower inner corner, and the Trace can also be improved by not eliminating the inner corner, but the transmittance is poorer in this case. In addition, it has been tested that eliminating both the upper inner corner and the lower inner corner only slows down the deflection time of the liquid-crystal molecules by about 1 to 2 second(s) compared to eliminating only the upper inner corner or the lower inner corner, which does not affect the display image quality. Thus, referring to FIG. 26, the result of the comparison of the influence factor of group (1) is that the inner corner can be canceled.

Referring to the comparison the influence factor of group (2) in FIG. 26, it can be seen that for the above single-domain pixel structure, Trace can be effectively improved by designing the angle α between the second edge z2 and the second edge z3 in the upper outer corner the outer corner angle) equal to 45 degrees or 60 degrees. In the case that the angle α between the second edge z2 and the second edge z3 is equal to 30 degrees, Trace is not improved, and group (2) fails. Thus, referring to FIG. 5, the result of the comparison of the influence factors of group (2) is that the angle α between the second edge z2 and the second edge z3 can be designed to be greater than or equal to 45 degrees.

Referring to the comparison the influence factor of group (3) in FIG. 26, it can be seen that for the above single-domain pixel structure, the Trace can be effectively improved by designing the length of the third edge z3 (i.e., the length of the outer corner) d1 in the upper outer corner to range between 2 and 5 μm. However, considering the process margin, it is recommended to design the outer corner length d1 greater than or equal to 3 μm.

Referring to the comparison the influence factor of group (4) in FIG. 26, it can be seen that for the above single-domain pixel structure, only one of the two outermost electrode branches L1 can be designed to have an outwardly protruding upper outer corner, while the other electrode branch L1 do not have an outwardly protruding upper outer corner to effectively improve Trace. The other electrode branch L1 not having the outwardly protruding upper outer corner indicates that the angle β between the extending direction Y3 and the extending direction Ys1 shown in FIG. 26 is less than or equal to 180 degrees, parallel to the slit direction, at an acute angle or at a right angle, etc. As a result, with reference to FIG. 26, the result of the comparison of the influence factor of group (4) is that: in the second electrode 02, the outer corner of the first end portion L11 on one side is retained, the outer corner of the first end portion L11 on the other side is cancelled, and the extending direction of one end of the first end portion L11 on the other side is the same as the slit direction.

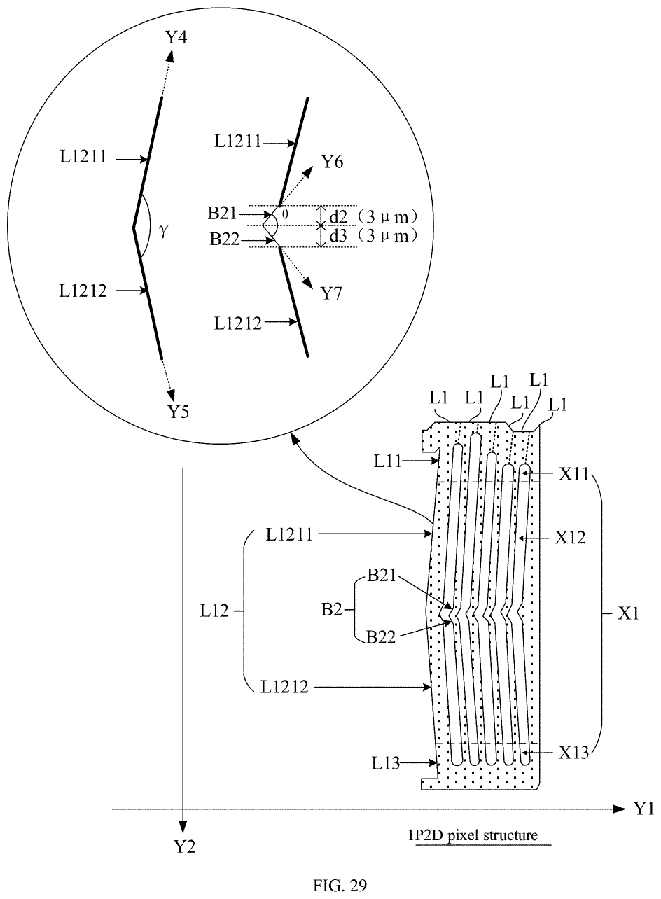

It should be noted that the single-domain pixel structure may include a 1P1D single-domain pixel structure and a 2PD single-domain pixel structure. Referring to FIG. 27, the 1P1D single-domain pixel structure can refer to two pixel structures disposed in one column and adjacent to each other, with the second electrode 02 folded and overlapped in the symmetry axis Z0 identical to the slit direction. Referring to FIG. 28, it can be seen that the single-domain pixel structure of 2PD can refer to two pixel structures disposed in one column and adjacent to each other, with the second electrode 02 folded along the symmetry axis Z0 without being overlapped and opposite the slit direction.

As another optional implementation, for the 1P2D two-domain pixel structure, with reference to FIG. 29, the body portion L12 of each of the electrode branches L1 may include a first body segment L1211 and a second body segment L1212 that are successively connected in the second direction Y2. i.e., the body portion L12 may have a total of two body segments.

The first body segment L1211 may be connected to the first end portion L11 and the second body segment L1212, and the second body segment L1212 may also be connected to the second end portion L13. The extending direction of the first end portion L11 and the extending direction of the first body segment L1211 may both be a fourth direction Y4, i.e., the extending direction is the same. The extending direction of the second end portion L13 and the extending direction of the second body segment L1212 are both in a fifth direction Y5, i.e., the extending direction is the same. The fourth direction Y4 and the fifth direction Y5 can be intersected with and the angle γ can be greater than 90 degrees and less than 180 degrees, i.e., not parallel. Based on the extending direction, it is known that the angle γ may refer to the angle between the first body segment L1211 and the second body segment L1212, and the angle γ is the angle toward the slit X1.

By setting the body portion L12 of the electrode branches L1 to include two body segments with the angle γ greater than 90 degrees and less than 180 degrees in the extending direction, normal deflection of the liquid-crystal molecules in the intermediate region can be ensured.

With continued reference to FIG. 29, it can be seen that at least one (e.g., each) body portion L1 of the electrode branch L1 may also include a corner portion B2, and the first body segment L1211 and the second body segment L1212 may be connected by the corner portion B2. The corner segment B2 may include a first corner portion B21 and a second corner portion B22 that are successively connected in the second direction Y2, and the first corner portion B21 is connected to the first body segment L1211 and the second corner portion B22 is connected to the second body segment L1212. That is, in the second direction Y2, the first body segment L1211, the first corner portion B21, the second corner portion B22, and the second body segment L1212 are successively connected. The corner portion B2 may also be referred to as an intermediate corner.

The first corner portion B21 extends in a sixth direction Y6 and the second corner portion B22 extends in a seventh direction Y7. The sixth direction Y6 is intersected with the fourth direction Y4. The seventh direction Y7 is intersected with the fifth direction Y5. And the sixth direction Y6 is intersected with the seventh direction Y7. In this way, it can be seen that any two of the first body segment L1211, the first Corner portion B21, the second corner portion B22, and the second body segment 1,1212, which are successively connected, are not parallel.

Optionally, referring to FIG. 29, an angle θ between the sixth direction Y6 and the seventh direction Y7 may be greater than or equal to 45 degrees and less than 180 degrees. Based on the extending direction, it is known that the angle θ actually refers to the angle between the first corner portion B21 and the second corner portion B22. That is, in the embodiment of the present disclosure, the angle between the first corner portion B21 and the second corner portion B22 can be greater than or equal to 45 degrees and less than 180 degrees. In other words, the angle θ of the first corner portion B21 and the second corner portion 1322 may be less than the angle γ of the first body segment L1211 and the second body segment 11212. Preferably, in the embodiment of the present disclosure, the angle θ may be equal to 45 degrees. It has been tested and verified that by setting the angle θ equal to 45 degrees, the Trace Mura problem can be effectively solved while ensuring the maximum transmittance.

Optionally, referring to FIG. 29, a depth d2 of the first corner portion B21 in the second direction Y2 and a depth d3 of the second corner portion B22 in the second direction Y2 may both be greater than or equal to 2 μm. i.e, the total depth of the intermediate corner in the second direction Y2 may be greater than or equal to 2+2 μm.

For example, considering the actual level of the process, in the embodiment of the present disclosure, referring to FIG. 29, the depth d2 of the first corner portion B21 in the second direction Y2 and the depth d2 of the second corner portion B22 in the second direction Y2 can both be equal to 3 μm. That is, the total depth of the intermediate corner in the second direction Y2 can be equal to 3+3 μm. Based on the embodiment, referring to FIG. 29, it can be seen that both the upper inner corner and the lower inner corner can be eliminated. That is, it is possible to arrange the angle g equal to 180 degrees between the first slit segment X11 and the second slit segment X12, and to arrange the angle g equal to 180 degrees between the third slit segment X13 and the second slit segment X12. It is verified that the pixel structure under this arrangement can guarantee the good transmittance of the display panel and effectively solve the Trace Mura. problem of the display panel.

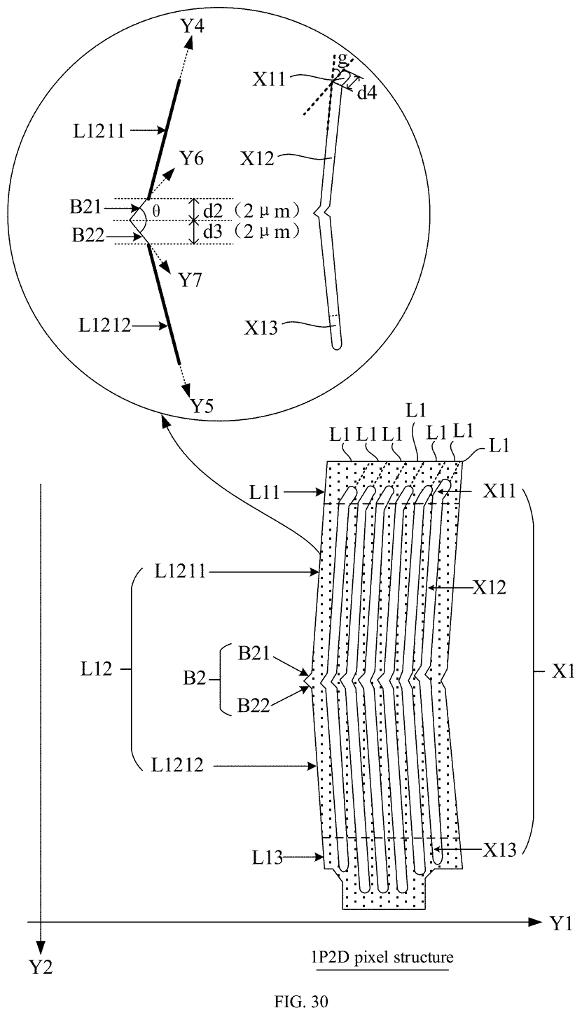

For example, referring to FIG. 30, in the embodiment of the present disclosure, it is also possible to design the depth d2 of the first corner portion B21 in the second direction Y2 and the depth d3 of the second corner portion B22 in the second direction Y2 to be equal to 2 μm. That is, it is possible to design the total depth of the intermediate corners in the second direction Y2 equal to 2+2 μm. Based on the embodiment, referring to FIG. 30, it can be seen that only the lower inner corner can be eliminated, while the upper inner corner can be retained. That is, it is possible to design the angle g at between the third slit segment X13 and the second slit segment X12 equal to 180 degrees and to design the angle g between the first slit segment X11 and the second slit segment X12 greater than or equal to 45 degrees and less than 180 degrees. Preferably, the angle g can be designed to be equal to 45 degrees. Furthermore, based on the structure, the width (which may also be called depth) d4 of the first slit segment X11 in the extending direction of the first slit segment X11 may be greater than or equal to 3 μm.

It should be noted that, for the embodiment structure shown in FIG. 30, it is mainly applicable to the structure in which the orthographic projection of the first end portion L11 on the substrate 10 is overlapped with the orthographic projection of the black matrix (BM) on the substrate 10 disposed on one side of the substrate 10. That is, the scenario where the upper corner is obscured by the BM is applicable. Because the transmittance, i.e., the luminous efficiency, cannot be improved even though the inner corner is eliminated in the scenario, reducing the depth of the middle corner can be considered to improve the luminous efficiency. That is, the total depth of the design intermediate corners is equal to 2+2 μm.

It should also be noted that the design of the total depth of the intermediate corner is related to the level of the equipment used to manufacture the intermediate corner, and it is sufficient to ensure that this intermediate corner has the shape shown in FIG. 29 or FIG. 30 above. The second electrode 02 illustrated in FIG. 29 includes six electrode branches L1 spaced sequentially in the first direction Y1. The second electrode 02 illustrated in FIG. 30 includes seven electrode branches L1 spaced sequentially in the first direction Y1. Embodiments of the present disclosure do not limit the number of electrode branches L1 included in the second electrode 02.

Optionally, in the embodiments of the present disclosure, the first electrode 01 and the second electrode 02 may both include indium tin oxide (IT0) material. The IT0 material is generally a transparent material, such that a better transmittance of the display panel can be further ensured. Based on this, in the first electrode 01 and the second electrode 02, the first electrode 01 that is relatively close to the substrate 10 can be referred to as IT01 and the second electrode 02 that is relatively distal from the substrate 10 can be referred to as IT02.

Optionally, the display mode employed in the display panel including the above pixel structure may be a high-advanced dimension switch (HADS) display mode with a high opening rate.

It is noted that a second electrode 02 may be a monolithic structure, and the various parts (e.g., electrode branch L1) included in the second electrode 02 as described in the above embodiment are not physically independent.

Combined with the above embodiments, it can be seen that the solution described in the present disclosure can effectively improve the Trace Mura problem while effectively enhancing the transmittance and contrast of the display panel by only optimizing the design of the second electrode 02 structure based on not changing the structure of the liquid-crystal box. The specific optimization design can be summarized as follows.

(1) For the 1P1D pixel structure or 2PD pixel structure, the inner corner is partially or completely eliminated, and only the outer corner on the same direction as the slit is retained, in which the angle α≥45° and the length d1≥2 μm.

(2) For 1P2D pixel structure, the inner corners are partially or completely cancelled, and the total depth of the designed intermediate corners is equal to 3+3 μ, and the angle θ=45°, and the outer corners can be completely cancelled.

In summary, embodiments of the present disclosure provide a pixel structure. The pixel structure includes a first electrode, a second electrode, and a liquid-crystal layer disposed on one side of a substrate and successively stacked. The second electrode includes a plurality of electrode branches arranged sequentially in the first direction, and each of the two adjacent electrode branches have slits between them. in the second direction intersecting the first direction, each of the electrode branches includes a first end portion, a body portion and a second end portion, and the slit includes a first slit segment, a second slit segment and a third slit segment, and the first end portions of the plurality of electrode branches are communicated with each other, and the second end portions are communicated with each other. Because the angle between the first slit segment and/or the third slit segment and the second slit segment is equal to 180 degrees, it is possible to make the communication of the first end portions and/or the communication of the second end portions of each of the two adjacent electrode branches do not have inner corners. In this way, the transmittance of the display panel can be made better. Based on this, the shape of the electrode branches can be flexibly set to improve the Trace Mura problem and a better display quality of the display panel is ensured.

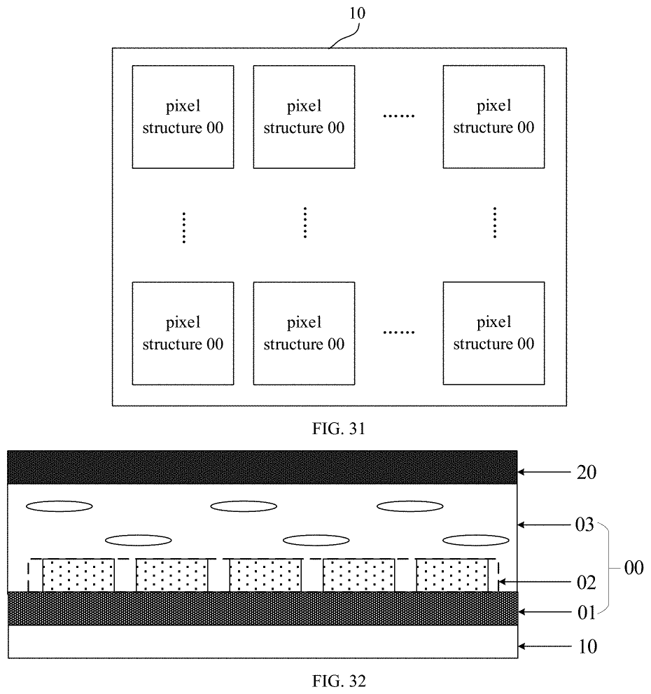

FIG. 31 is a schematic diagram of a structure of a display panel according to some embodiments of the present disclosure. FIG. 32 is a schematic diagram of the structure of another display panel according to some embodiments of the present disclosure.

Referring to FIG. 31 and FIG. 32, it can be seen that the display panel may include a substrate 10, a plurality of pixel structures 00 disposed on one side of the substrate 10 as shown in the accompanying drawings above, and a color filter CF 20 disposed on one side, distal from the substrate 10, of the pixel structures 00 which may also be referred to as a CF substrate. Optionally, with reference to FIG. 31, it can also be seen that the plurality of pixel structures 00 can be arranged in an array. Based on the above embodiments, it can be seen that the display panel including the pixel structure 00 has better transmittance and contrast without Trace.

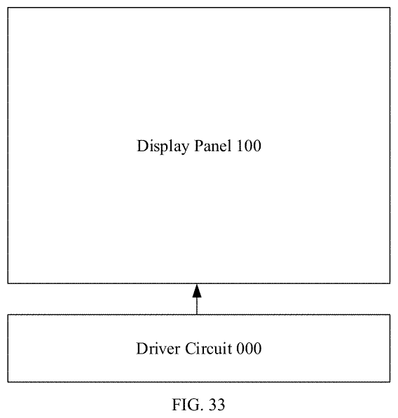

FIG. 33 is a schematic diagram of the structure of a display device according to some embodiments of the present disclosure. As shown in FIG. 33, the display device may include a driver circuit 000, and a display panel 100 as shown in FIG. 31 or FIG. 32.

The driver circuit 000 may be connected to the display panel 100 and provide a drive signal to the pixel structure 00 in the display panel 100, thereby driving the pixel structure 00 to emit light. For example, the driver circuit 000 may provide a common voltage to a common electrode in the pixel structure 00.

Optionally, the display device described in embodiments of the present disclosure may be an LCD display device, a cell phone, a tablet computer, a flexible display device, a television set, and a monitor, and any other product or component having a display function.

The terms used in the embodiments of the present disclosure are used only for the purpose of explaining embodiments of the present disclosure and are not intended to limit the present disclosure. Unless otherwise defined, technical terms or scientific terms used in embodiments of the present disclosure shall have the ordinary meaning as understood by persons having ordinary skill in the art to which the present disclosure belongs.

For example, the words “first,” “second,” or “third” and the like as used in the specification of the patent application and claims of the disclosure do not indicate any order, number, or importance, but only to distinguish the different components.

Similarly, the words “a” or one and the like do not indicate a quantitative but rather the presence of at least one.

Similar words such as “includes” or “contains” are intended to indicate that the component or object present before “includes” or “contains” covers. The element or object preceding “includes” or “contains” covers the element or object appearing after “includes” or “contains” and its equivalent, and does not exclude other elements or objects.

The terms “up”, “down”, “left” or “right” are used only to indicate relative positional relationships. When the absolute position of the object being described changes, the relative position relationship may also change accordingly.

“And/or” indicates that three relationships may exist, e.g., A and/or B, which may indicate the presence of A alone, the presence of both A and B, and the presence of B alone. The character “/” generally indicates an “or” relationship between the associated former objects and later objects.

The above is only an optional embodiment of the present disclosure and is not intended to limit the present disclosure. Any modification, equivalent replacement, improvement, etc. made within the spirit and principles of the present disclosure shall be included in the scope of protection of the present disclosure.

The above descriptions are merely optional embodiments of the present disclosure and are not intended to limit the present disclosure. Any modification, equivalent replacement, improvement, or the like made within the spirit and principle of the present disclosure shall fall within the protection scope of claims of the present disclosure.

What is claimed is:

1. A pixel structure, comprising:
a first electrode, a second electrode, and a liquid crystal layer that are disposed on one side of a substrate and successively stacked, wherein one of the first electrode and the second electrode is a pixel electrode and the other of the first electrode and the second electrode is a common electrode, and the second electrode comprises:
a plurality of electrode branches sequentially arranged in a first direction, wherein each of the electrode branches comprises a first end portion, a body portion, and a second end portion that are successively connected in a second direction, the body portion comprising at least one body segment, an extending direction of each of the body segments, an extending direction of the first end portion and an extending direction of the second end portion being intersected with the second direction, and the second direction being perpendicular to the first direction;
wherein the first end portions of the plurality of electrode branches are communicated with each other, the second end portions of the plurality of electrode branches are communicated with each other, the first end portions of at least two electrode branches are communicated with each other in an arc, the second end portions of at least two electrode branches are communicated with each other in an arc, and a slit is disposed between each of the two adjacent electrode branches, the slit comprising a first slit segment, a second slit segment and a third slit segment that are successively connected in the second direction, and an angle between at least one of the first slit segment and the third slit segment and the second slit segment being equal to 180 degrees.

2. The pixel structure according to claim 1, wherein the first electrode is a common electrode, and the second electrode is a pixel electrode.

3. The pixel structure according to claim 1, further comprising: a thin film transistor, wherein the second electrode further comprises a connection portion;
wherein the thin film transistor is connected to the second end portion of the plurality of electrode branches by the connection portion, and is configured to supply a voltage to the plurality of electrode branches.

4. The pixel structure according to claim 1, wherein the body portion of each of the electrode branches comprises the body segment, and the extending direction of the body segment, the extending direction of the first end portion, and the extending direction of the second end portion are a third direction; and
in the plurality of electrode branches, one end of the first end portion in a first target electrode branch protrudes in a direction away from remaining electrode branches except the first target electrode branch;
wherein the first target electrode branch is an outermost electrode branch of the plurality of electrode branches, and a protruding direction of the first end portion of the first target electrode branch is a same direction as an inclining direction of the first end portion, and the inclining direction of the first end portion is an inclining direction of the first end portion to a side distal from the body portion.

5. The pixel structure according to claim 4, wherein in the plurality of electrode branches, one end of the second end portion of in a second target electrode branch protrudes in a direction away from remaining electrode branches except the second target electrode branch;
wherein the second target electrode branch is another outermost electrode branch of the plurality of electrode branches, and a protruding direction of the second end portion of the second target electrode branch is in a same direction as an inclining direction of the second end portion, and the inclining direction of the second end portion is an inclining direction of the second end portion to a side distal from the body portion.

6. The pixel structure according to claim 5, wherein in the second target electrode branch, an angle between the extending direction of the first end portion distal from the first target electrode branch and the third direction is less than or equal to 180 degrees.

7. The pixel structure according to claim 5, wherein a protruding end of the first target electrode branch and a protruding end of the second target electrode branch both comprise a first edge, a second edge, a third edge, and a fourth edge that are successively connected;
wherein the first edge extends in the first direction, the second edge extends in the third direction, an extending direction of the third edge is intersected with the third direction at an angle greater than or equal to 45 degrees and a length of the third edge is greater than or equal to 2 μm, and the fourth edge extends in a direction intersecting the extending direction of the third edge.

8. The pixel structure according to claim 7, wherein an angle between the extending direction of the third edge and the third direction is equal to 45 degrees or 60 degrees.

9. The pixel structure according to claim 7, wherein a length of the third edge is less than or equal to 5 μm.

10. The pixel structure according to claim 9, wherein the length of the third edge is greater than or equal to 3 μm.

11. The pixel structure according to claim 1, wherein the body portion of each of the electrode branches comprises a first body segment and a second body segment that are successively connected in the second direction;
wherein the first body segment is connected to the first end portion and the second body segment, and the second body segment is further connected to the second end portion;
wherein an extending direction of the first end and an extending direction of the first body segment are both a fourth direction, and an extending direction of the second end portion and an extending direction of the second body segment are both a fifth direction, the fourth direction being intersected with the fifth direction at an included angle between the fourth direction and the fifth direction greater than 90 degrees and less than 180 degrees.

12. The pixel structure according to claim 11, wherein at least one of the body portions of the electrode branches further comprises a corner portion, and the first body segment is connected to the second body segment by the corner portion;
wherein the corner portion comprises a first corner portion and a second corner portion connected in the second direction, the first corner portion is connected to the first body segment, and the second corner portion is connected to the second body segment;
wherein the first corner portion extends in a sixth direction and the second corner portion extends in a seventh direction; wherein the sixth direction is intersected with the fourth direction;
the seventh direction is intersected with the fifth direction; the sixth direction being intersected with the seventh direction, and an angle between the sixth direction and the seventh direction is greater than or equal to 45 degrees and less than 180 degrees; and a depth of the first corner portion in the second direction and a depth of the second corner portion in the second direction are both greater than or equal to 2 μm.

13. The pixel structure according to claim 12, wherein an angle between the sixth direction and the seventh direction is equal to 45 degrees.

14. The pixel structure according to claim 12, wherein a depth of the first corner portion in the second direction and a depth of the second corner segment in the second direction are both equal to 3 μm.

15. The pixel structure according to claim 12, wherein
a depth of the first corner portion in the second direction and a depth of the second corner segment in the second direction are both equal to 2 μm;
an orthographic projection of the first end on the substrate is overlapped with an orthographic projection of a black matrix disposed on one side of the substrate on the substrate; and
an angle between the third slit segment and the second slit segment is equal to 180 degrees, an angle between the first slit segment and the second slit segment is greater than or equal to 45 degrees and less than 180 degrees, and a width of the first slit segment is greater than or equal to 3 μm in an extending direction of the first slit segment.

16. The pixel structure according to claim 15, wherein the angle between the first slit segment and the second slit segment is equal to 45 degrees.

17. The pixel structure according to claim 1, wherein an angle between the first slit segment and the second slit segment is equal to 180 degrees, and an angle between the third slit segment and the second slit segment is equal to 180 degrees.

18. The pixel structure according to claim 1, wherein the first electrode and the second electrode both comprises an indium tin oxide material.

19. A display panel, comprising: a substrate, a plurality of pixel structures, and a color filter disposed on a side, distal from the substrate, of the pixel structures;
wherein the each of the pixel structures comprises:
a first electrode, a second electrode, and a liquid crystal layer that are disposed on one side of a substrate and successively stacked, wherein one of the first electrode and the second electrode is a pixel electrode and the other of the first electrode and the second electrode is a common electrode, and the second electrode comprises:
a plurality of electrode branches sequentially arranged in a first direction, wherein each of the electrode branches comprises a first end portion, a body portion, and a second end portion that are successively connected in a second direction, the body portion comprising at least one body segment, an extending direction of each of the body segments, an extending direction of the first end portion and an extending direction of the second end portion being intersected with the second direction, and the second direction being perpendicular to the first direction;
wherein the first end portions of the plurality of electrode branches are communicated with each other, the second end portions of the plurality of electrode branches are communicated with each other, the first end portions of at least two electrode branches are communicated with each other in an arc, the second end portions of at least two electrode branches are communicated with each other in an arc, and a slit is disposed between each of the two adjacent electrode branches, the slit comprising a first slit segment, a second slit segment and a third slit segment that are successively connected in the second direction, and an angle between at least one of the first slit segment and the third slit segment and the second slit segment being equal to 180 degrees.

20. A display device, comprising: a drive circuit, and a display panel;
wherein the drive circuit is connected to the display panel, and is configured to drive signals to a plurality of pixel structures in the display panel; and
the display panel comprises: a substrate, the plurality of pixel structures, and a color filter disposed on a side, distal from the substrate, of the pixel structures;
wherein each of the pixel structures comprises:
a first electrode, a second electrode, and a liquid crystal layer that are disposed on one side of a substrate and successively stacked, wherein one of the first electrode and the second electrode is a pixel electrode and the other of the first electrode and the second electrode is a common electrode, and the second electrode comprises:
a plurality of electrode branches sequentially arranged in a first direction, wherein each of the electrode branches comprises a first end portion, a body portion, and a second end portion that are successively connected in a second direction, the body portion comprising at least one body segment, an extending direction of each of the body segments, an extending direction of the first end portion and an extending direction of the second end portion being intersected with the second direction, and the second direction being perpendicular to the first direction;
wherein the first end portions of the plurality of electrode branches are communicated with each other, the second end portions of the plurality of electrode branches are communicated with each other, the first end portions of at least two electrode branches are communicated with each other in an arc, the second end portions of at least two electrode branches are communicated with each other in an arc, and a slit is disposed between each of the two adjacent electrode branches, the slit comprising a first slit segment, a second slit segment and a third slit segment that are successively connected in the second direction, and an angle between at least one of the first slit segment and the third slit segment and the second slit segment being equal to 180 degrees.
